(19) United States
(12) Patent Application Publication
(10) Pub. No.: US 2012/0274199 A1
(43) Pub. Date: Nov. 1, 2012

(54) Electric lamp with an outer bulb and a built-in lamp and associated production method

(75) Inventors: Roland Becht, Dorlisheim (FR); Eric Korndoerfer, Herbrechtingen (DE); Roland Stark, Wellheim (DE)

(73) Assignee: OSRAM AG, Muenchen (DE)

(21) Appl. No.: 13/457,528

(22) Filed: Apr. 27, 2012

(30) Foreign Application Priority Data
Apr. 27, 2011 (DE) 20 2011 005 637.6

(51) Int. Cl. H01J 61/36; H01J 9/26; H01J 5/16

(52) U.S. Cl. 313/113; 313/623; 445/44

(57) ABSTRACT

In various embodiments, an electric lamp with an outer bulb and with a base fastened by means of a plate-like stand and a built-in lamp with a longitudinal axis, the outer bulb surrounding the built-in lamp, which is equipped with pinch seal with two narrow and two broad sides, two outer power supply lines protruding out of pinch seal being electrically conductively connected to feedlines leading to the base, built-in lamp being held without cement by a holding clip, wherein the holding clip has at least one clip part, including a basic body bent in the form of a U, two spring tongues being arranged on the basic body such that they embrace the broad sides of the pinch seal, a docking station for a feedline attached to the basic body, and contact being made between the basic body and an outer power supply line.

### RELATED APPLICATIONS

The present application claims priority according to 35 U.S.C. §119 from German Application No. 20 2011 005 637.6, filed on Apr. 27, 2011.

### TECHNICAL FIELD

Various embodiments related in particular to an electric lamp with a base at one end and with an outer bulb held in a base and at least one built-in lamp arranged within the outer bulb. Such halogen incandescent lamps are envisaged in particular for operation at a high voltage (HV) of typically from 100 to 250 V.

### BACKGROUND

EP-A 2 239 762 has disclosed a holder for a built-in lamp in an outer bulb, the holder having a metal mounting clip which rests on the end of a plate-like stand.

Conventionally, in this case, the outer power supply lines led out from the built-in lamp are fixedly connected to the feedlines protruding out of the plate-like stand for locking purposes. Complex machine technology is required for this purpose.

### SUMMARY

Various embodiments provide a built-in lamp in an outer bulb by means of a mounting clip securely and reliably

As a departure from a highly automated process, what is now proposed is a novel fitting concept which manages without complex adjustment.

Various embodiments provide for the simple and reliable production of a lamp with a built-in lamp. Embodiments provide an electric lamp with a base at one end and with an outer bulb fastened to a base and a built-in lamp arranged within the outer bulb, it being possible for said lamp to be produced robustly and in a simple manner. Preferably, the lamp or built-in lamp is a high-voltage halogen incandescent lamp, with at least two pins acting as power supply wires. However, the lamp can also be a high-pressure discharge lamp. The built-in lamp has a bulb with a pinch seal, which is held by means of a holding clip on the plate-like stand.

The lamp or built-in lamp substantially comprises a hermetically sealed lamp vessel or bulb with a pinch seal, at least one light-emitting means and a power supply system for the light-emitting means which generally also has two outer power supply lines, which protrude axially parallel out of the pinch seal. The light-emitting means is normally a light-emitting element, but it may also be a discharge arc between two electrodes. In the text which follows, the light-emitting means will always be described as a light-emitting element, for reasons of simplicity. It is often connected to the outer power supply lines via inner power supply lines and possibly foils or films.

The power supply system connects the light-emitting element arranged in the interior of the lamp vessel to a base, which is arranged outside the lamp vessel and is intended to be connected to a current source. The power supply system comprises, for example, inner power supply wires, fuse-seal foils or films and outer power supply wires, the ends, aligned towards one another, of the inner and outer power supply wires and the fuse-seal foils or films which connect the power supply wires to one another are fused in the lamp pinch seal. In certain embodiments only the pinch seal and the wires of the outer power supply lines which protrude outwards from said pinch seal. The bulb is generally filled with an inert gas and a halogen additive. Instead of an incandescent lamp, it is also possible for a high-pressure discharge lamp to be used, in particular as the built-in lamp, similar to that described in DE-A 32 32 207.

Therefore, the power supply line is connected to a holding clip, which takes on the function, for this power supply line, of further contact making towards the base.

Various embodiments are suitable in particular for increasing the luminous flux of the lamp. The object is thus achieved of increasing the efficiency of such lamps in a manner which is as simple as possible.

The holding clip comprises two clip parts which are independent of one another and can in principle be identical, even if mirror-inverted. The design of a holding clip part, often merely referred to as clip part, will be described in more detail below.

The clip part has a pair of spring tongues for fixing the pinch seal of the built-in lamp and a docking station for the feedline which protrudes out of a plate-like stand upwards towards the built-in lamp, and at least also a basic body, which ensures the connection between the feedline and the associated outer power supply line of the built-in lamp and at the same time either surrounds the pinch seal laterally or acts as a stop for the footing of the pinch seal. The outer power supply lines of the built-in lamp emerge from this footing.

In a preferred embodiment, the basic body is bent in the form of a U, with two side walls and a base wall. In particular, the two spring tongues are each attached to one of the side walls of the basic body.

Advantageously, the basic body and the docking station are at a different height level with respect to the longitudinal axis, as a result of which a quite considerable material saving in comparison with EP 2239762 is achieved, together with the spring tongues. In said document, the basic body and the docking station are at the same height level, for which reason approximately twice as much material is required for the holding clip part. At the same time, the holding clip can now be matched even better to the pinch seal of the built-in lamp.

It is also advantageous that a reflector part is connected to the clip part, the reflector part preferably being arranged substantially transversely to the longitudinal axis of the built-in lamp. Preferably, the reflector part is a segment of a disk; it can substantially be understood in particular to be a segment of a circle. The reflector part can be mechanically connected to the clip part or integrally formed thereon.

The pinch seal of the built-in lamp is preferably held in the region of a lateral rim of the pinch seal by means of two spring tongues which are opposite one another. Correspondingly, identical spring tongues of a second holding clip part can also hold the opposite second lateral rim of the pinch seal.

The spring tongues end at side walls of a U-shaped base part, which still has a base wall. The three walls are approximately at right angles with respect to one another, and the basic area of the side wall and the base wall are approximately the same size, preferably they differ from one another by at most 30% of the area, and are oriented axially parallel to the longitudinal axis of the built-in lamp.

Advantageously, a centering part which is bent back approximately at right angles extends from the base wall into the area between the two spring tongues. The centering part has an opening in its inner face which acts as a centering run-in portion for an outer power supply line of the built-in lamp. This opening can lie completely within the rim of the centering part, but it may also extend as a cutout partially up to the rim. All of the parts are advantageously planar faces which are connected to one another via bends.

Two pins are positioned opposite the spring tongues on the side walls as an option, the reasoning behind this option being explained further below. If the spring tongues are considered as adjoining the upper edge of the side wall, these pins therefore rest on the lower edge, preferably as an extension of the spring tongue.

In addition, an approximately rectangular auxiliary plate is attached to the free end edge of a first side wall and is arranged through approximately 90° laterally with respect to the first side wall. It is preferably oriented parallel to the base wall.

A U-shaped clamping part is attached as docking station to the auxiliary plate, possibly via a plate-like deflection part, with two side walls which are oriented such that they are aligned parallel to the free end of a feedline, which protrudes out of the plate-like stand of the lamp and is supplied from the base. The distance between the two side walls is selected precisely such that the feedline or the free end thereof can be clamped therein, which possibly takes place by subsequent matching of this distance, as a result of which a good clamping effect is ensured. Since this distance is relatively short, the base part is rather modest in comparison with the side walls. Often it is merely a bent connecting piece. In order to save on materials and for easier bending, the clamping part often has cut-out windows in the region of the base part.

The two spring tongues are substantially parallel to one another and axially parallel to the longitudinal axis of the lamp. They bear in clamping fashion against the two broad sides of the pinch seal.

For secure fixing of the pinch seal without any play, the free ends of the spring tongues are preferably corrugated.

With such a holding clip, it was possible to reduce the number of rejects during fitting of the built-in lamp in the base to approximately a third of the previously conventional value.

In the simplest embodiment of the holding clip, the fitting of the base takes place by virtue of two holding clip parts acting as holder for the built-in lamp, said holding clip parts surrounding the pinch seal of the built-in lamp. In this case, the holding clip parts are docked onto the feedlines which protrude out of the plate-like stand, as illustrated above. Then, they are fixed by means of laser welding. Then, a conventional base is attached.

During fitting of the clip part, the feedlines protruding out of the plate-like stand are also fitted between the side walls of the clamping part or the docking station. Possibly, the distance between the side walls of the clamping part is then reduced.

A secure connection is preferably achieved by laser welding between the feedline and the clamping part, similarly to the procedure which is also used between the outer power supply line and the extension part of the base wall of the clip part, in particular even both welding operations are performed simultaneously or directly successively.

In a particularly preferred embodiment, the efficiency of the lamp is increased by virtue of the luminous flux losses in the direction of the base being minimized. For this purpose, the frame structure is altered and the production method for fitting of the base is matched correspondingly.

This takes place by virtue of a reflector disk, which is in principle in the form of a semicircle or circle segment, being plugged onto the clip, this reflector disk being joined, wherein the disk has two slots, into which the abovementioned pins of the clip part are inserted.

The reflector disk also preferably has a first cutout, which is preferably rectangular, for the plate-like stand.

In addition, it preferably has a second cutout for the outer power supply line of the built-in lamp, between the two slots. This second cutout can be arranged in particular in such a way that it directly adjoins the first cutout. Both cutouts can be rectangular; in particular the longitudinal axes of the two cutouts are arranged transversely with respect to one another.

Prior to the base being fitted, each outer power supply line of the built-in lamp is bent back laterally towards the adjacent narrow side of the pinch seal and passed back again to said pinch seal, preferably slightly protruding.

The built-in lamp is placed onto the clip or onto two clip parts, and the free end of the bent-back outer power supply line is fastened on the clip part by laser or else resistance welding; in principle mechanical contact is also sufficient.

Then, a reflector disk is placed at the bottom onto the clip part with the result that the pins of the clip part latch into the slot in the reflector disk, and the free ends of the pins are then bent back, with the result that locking of the reflector disk is ensured.

Advantages of adding the reflector disks are that, by means of the minimized shading of the clip, the loss of luminous flux of the built-in lamp is kept as low as possible. In addition, the use of the reflector part reduces the luminous flux losses.

By virtue of the optimally configured clip part with minimal shading on the pinch seal of the built-in lamp and the use of the reflector disks, the luminous flux losses are reduced. Fitting takes place by virtue of the reflector disks, which are preferably manufactured from metal, in this case in particular aluminum-plated or high-gloss-coated or plated or chromium-plated, being fitted on the clip part. This takes place by the pins being bent back or by means of pressure being applied. Second clip parts are placed onto the built-in lamp simultaneously or in quick succession; the bent outer power supply lines of the built-in lamp are automatically centered in the centering run-in portion of the clip part. The outer power supply line of the built-in lamp with the clip part is preferably produced by means of laser welding. The structural unit comprising the built-in lamp and the clip parts is placed onto the two feedlines, which protrude out of the plate-like stand, and then the connection is secured by means of laser welding or the like, in this case too.

In another embodiment, the bent-back free end of the outer power supply line latches in on further latch-in springs of the clip part, with the result that no extra welding is required.

Preferably, the auxiliary plate can have a supporting element, which is attached transversely to the longitudinal axis, for the reflector disk.

The reflector disk has, substantially as a rim, a circular arc and a straight edge, which connects the ends of the circular arc.

Advantageously, the reflector disk is equipped at one or else both ends of the straight edge with a fin protruding therefrom, it being possible in particular for the fin to be bent back upwards. As a result, the reflecting surface which is spanned by the two reflector disks together is markedly increased in size. If both reflector disks have such a fin in mirror-inverted fashion with respect to one another, extensive back-reflection of radiation emitted in the direction of the base is ensured. The bend in the fin in this case ensures the possibility of overlap with respect to the adjacent reflector disk without a distance needing to be retained for reasons of tolerance.

In a further embodiment, the reflector disk is not a separate part, but is attached integrally to the holding clip.

Preferred material for the holding clip is spring steel or sheet metal.

Various embodiments include:
1. An electric lamp with an outer bulb and with a base fastened thereto by means of a plate-like stand and also with a built-in lamp with a longitudinal axis, the outer bulb surrounding the built-in lamp, which is equipped with a pinch seal with two narrow sides and two broad sides, two outer power supply lines protruding out of the pinch seal and being electrically conductively connected for their part to feedlines leading to the base, the built-in lamp being held without the use of cement by a holding clip, wherein the holding clip has at least one clip part, which has a basic body which is bent in the form of a U, two spring tongues being arranged on the basic body in such a way that they embrace the broad sides of the pinch seal, a docking station for a feedline also being attached to the basic body, and contact being made between the basic body and an outer power supply line.
2. The exemplary lamp of paragraph 1, wherein the basic body and the docking station are positioned at different heights with respect to the longitudinal axis.
3. The exemplary lamp of paragraph 1, wherein the basic body has a base wall, and two side walls, a centering run-in portion for the outer power supply line being bent back from the basic body.
4. The exemplary lamp of paragraph 1, wherein the basic body and the docking station are connected via an auxiliary plate, which is bent back towards the basic body.
5. The exemplary lamp of paragraph 1, wherein a reflecting disk segment, which extends transversely to the longitudinal axis, is associated with the clip part.
6. The exemplary lamp of paragraph 1, wherein the basic body has pin-like protuberances, the disk segment having corresponding cutouts for locking the disk segment.
7. The exemplary lamp of paragraph 1, wherein the disk segment is attached integrally to the basic body, in particular to a side wall of the basic body.
8. The exemplary lamp of paragraph 1, wherein the outer power supply line is bent back laterally towards the narrow side of the pinch seal.
9. The exemplary lamp of paragraph 1, wherein the disk segment additionally has a fin, which enlarges the area for the reflection.
10. The exemplary lamp of paragraph 1, wherein a stirrup-shaped latch-in spring for making contact with the bent-back outer power supply line is attached to the basic body, in particular with a rigid limb which is fastened on the basic body, a bridge part and a free limb, which presses laterally against the outer power supply line.
11. A method for producing an electric lamp as illustrated in paragraph 1, wherein, in a first step, an extension wire is connected to a second outer power supply line of the built-in lamp, then the built-in lamp is mechanically connected to the holding clip, the skirt is placed in particular between at least two spring tongues, then the first outer power supply line is connected directly to the skirt, in particular by means of a bead formed on the skirt, then cement is introduced into the base sleeve, then the structural unit comprising the built-in lamp and the holding clip is placed into the base sleeve whilst making contact between the spring feet and the base sleeve, then the outer bulb is placed onto the base sleeve, then the cement is baked, and finally the contact plate is connected to the extension wire.
12. A method for producing an electric lamp as illustrated in paragraphs 9 or 10, wherein, in a first step, an extension wire is connected to a second outer power supply line of the built-in lamp, then the built-in lamp is threaded through the reflector part and is mechanically connected to the holding clip, the skirt is placed in particular between at least two spring tongues, then the first outer power supply line is connected directly to the skirt, in particular by means of a bead formed on the skirt, then cement is introduced into the base sleeve, then the structural unit comprising the built-in lamp and the holding clip is placed into the base sleeve so as to make contact between the spring feet and the base sleeve, then the outer bulb is placed onto the base sleeve, then the cement is baked, and finally the contact plate is connected to the extension wire.

### BRIEF DESCRIPTION OF THE DRAWINGS

In the drawings, like reference characters generally refer to the same parts throughout different views. The drawings are not necessarily to scale, emphasis instead being generally upon illustrating the principles of the invention. In the following description, various embodiments are described with reference to the following drawings, in which:

FIG. 1 shows a basic illustration of a lamp according to the invention;

FIG. 2 shows a built-in lamp in detail;

FIG. 3 shows a detail of the built-in lamp with the holding clip;

FIG. 4 shows a view of the docking region from above (FIG. 4a) and in detail (FIG. 4b);

FIG. 5 shows a perspective view of a clip part;

FIG. 6 shows a view of the built-in lamp with the holding clip in two perspectives (FIGS. 6a and 6b);

FIG. 7 shows a further exemplary embodiment of a clip element with a reflector disk;

FIG. 8 shows a view of a built-in lamp with the holding clip as per the clip element shown in FIG. 7 in two perspectives (FIGS. 8a and 8b);

FIG. 9 shows a further exemplary embodiment of a clip element in two perspectives (FIGS. 9a and 9b);

FIG. 10 shows a detail of a built-in lamp with a holding clip as per the clip element shown in FIG. 9;

FIG. 11 shows a further exemplary embodiment of a clip element;

FIG. 12 shows a side view of a detail of a built-in lamp with a holding clip as per the clip element shown in FIG. 11;

FIG. 13 shows a perspective view of a detail of a built-in lamp with a holding clip as per the clip element shown in FIG. 11;

FIG. 14 shows a further exemplary embodiment of a clip element.

### DETAILED DESCRIPTION

The following detailed description refers to the accompanying drawings that show, by way of illustration, specific details and embodiments in which the invention may be practiced.

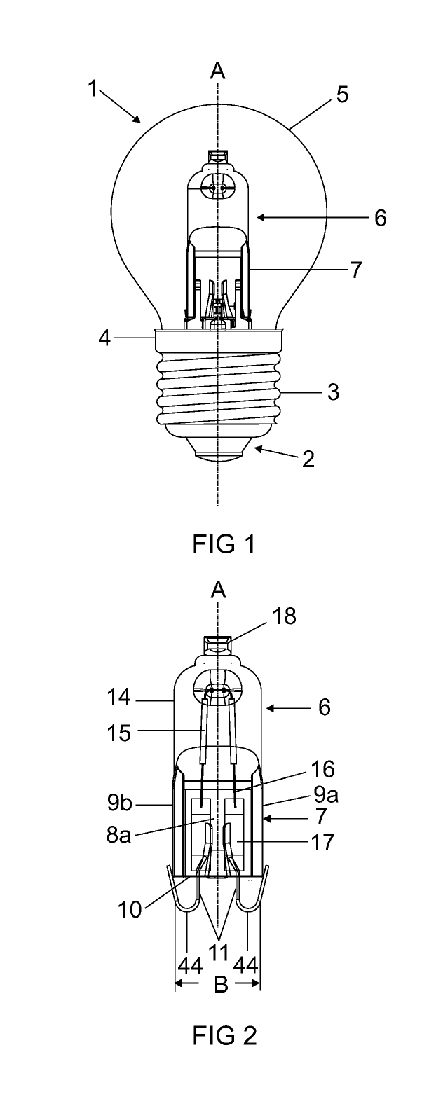

FIG. 1 illustrates a complete halogen incandescent lamp 1. In a base 2 of the conventional type E14 or E27, in particular with a ceramic base insulator or lamp mount and a screw part 3 fastened thereto and a base sleeve 4, an outer bulb 5 is held by means of cement in the base sleeve 4. A built-in lamp 6 is arranged within the outer bulb 5. The built-in lamp is in the form of a so-called high voltage halogen incandescent lamp and is known as such from the prior art. The lamp 1 has a longitudinal axis A, on which the built-in lamp is also aligned.

The built-in lamp 6 (see also FIG. 2) is equipped with a single pinch seal 7, which has two broad sides 8a and 8b and two narrow sides 9a and 9b as well as a bottom part 10. Pin-like outer power supply lines 11 protrude out of the pinch seal 7. As shown in FIG. 2, these outer power supply lines 11 are bent back outwards in the direction of the narrow side of the pinch seal, the free ends protruding outwards at a slight angle. At a slight angle means, in particular, at an angle of from 5 to 30° with respect to the longitudinal axis A.

The built-in lamp 6 is, for example, a halogen incandescent lamp with a pinch seal at one end and with a lamp vessel 14, in which a light-emitting element 15 is fixed. The light-emitting element 15 is electrically conductively connected to the base 2 via a power supply system. The power supply system comprises, connected to the light-emitting element 15, inner power supply wires 16, fuse-seal foils or films 17 and outer power supply wires 11. Those ends of the inner power supply wires 16 which are facing away from the light-emitting element 15, the fuse-seal foils or films 17 and those ends of the outer power supply wires 11 which face the fuse-seal foils or films are fused in the pinch seal 7, which terminates the lamp vessel 14.

The lamp vessel 14 is filled with an inert gas and halogen additive. The lamp vessel 14 is fuse-sealed (18) at its end opposite the pinch seal 7. The lamp vessel 14 is thus closed off from the outside in hermetically sealing fashion.

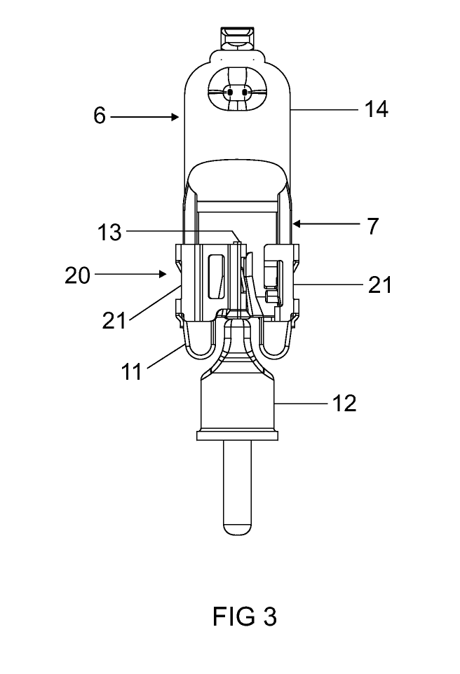

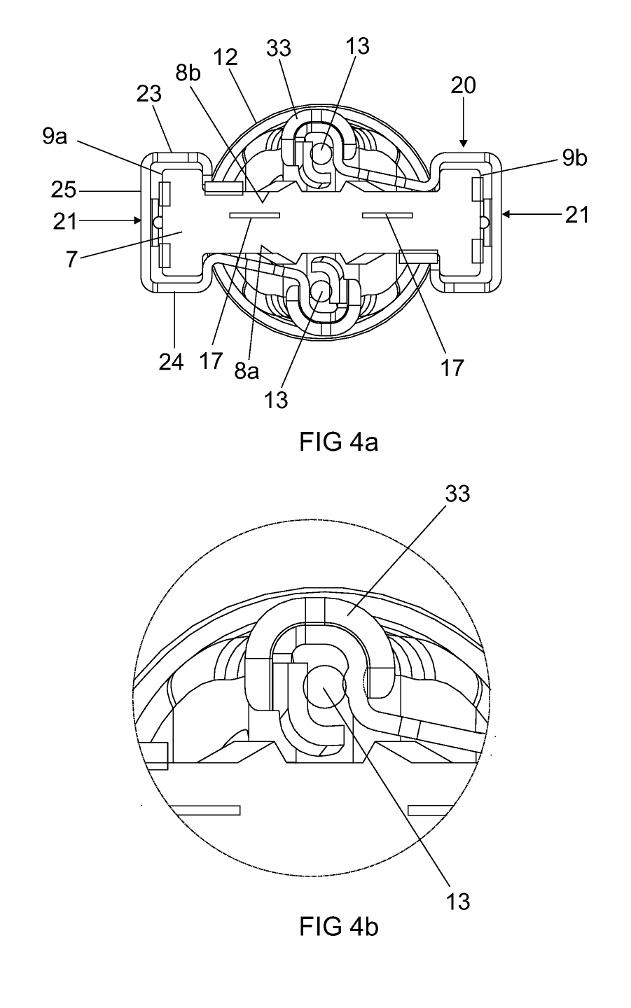

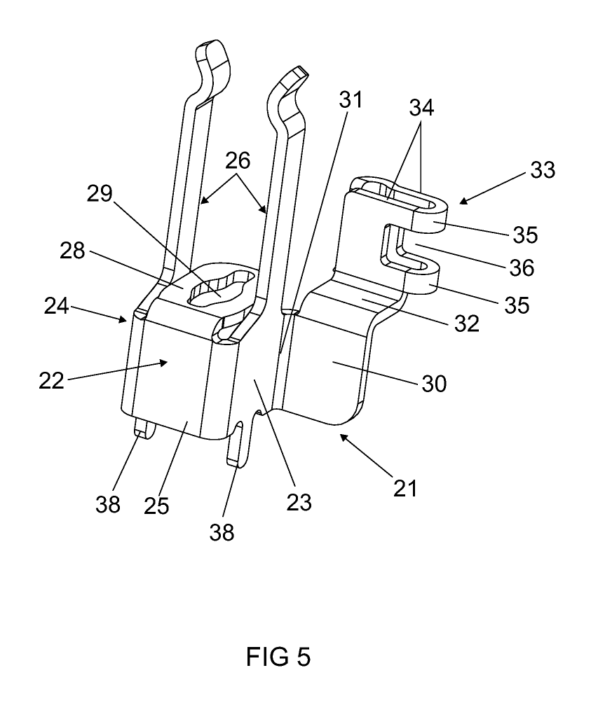

The built-in lamp 6 is held by a sheet-metal-like or spring-steel-like holding clip 20 in the base (see FIGS. 3 and 4). The holding clip 20 comprises two clip elements 21, which are substantially mirror-symmetrical.

The clip 20 rests on the pinch seal 7. In each case, one clip element 21 connects an outer power supply line 11 via a basic body and a docking station to a feedline 13 coming from the base, said feedline being fuse-sealed in a plate-like stand 12.

FIGS. 4a and 4b each show a section through the pinch seal 7 with the holding clip 20 and a detail of the docking station 33.

FIG. 5 shows a clip element 21 with a plate-like basic body 22, which is divided into three plate elements in the form of a U. A first plate element is a side wall 23. It is aligned parallel to the axis A and approximately as an extension of the second broad side 8b of the pinch seal 7 and is arranged directly beneath the pinch seal 7. The first side wall 23 has an upper rim, which points towards the pinch seal, and a lower rim, which points towards the base, an inner rim, which points away from the axis A, and an outer rim, which points towards the axis A.

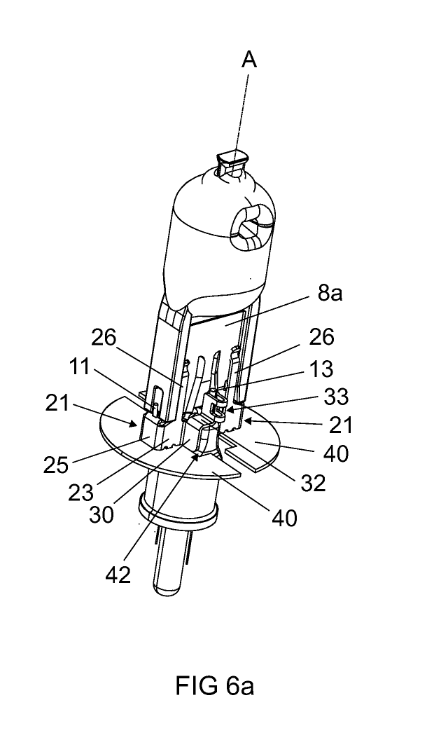

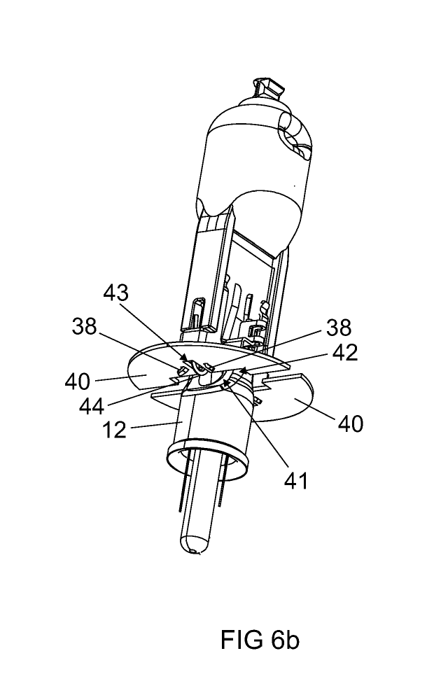

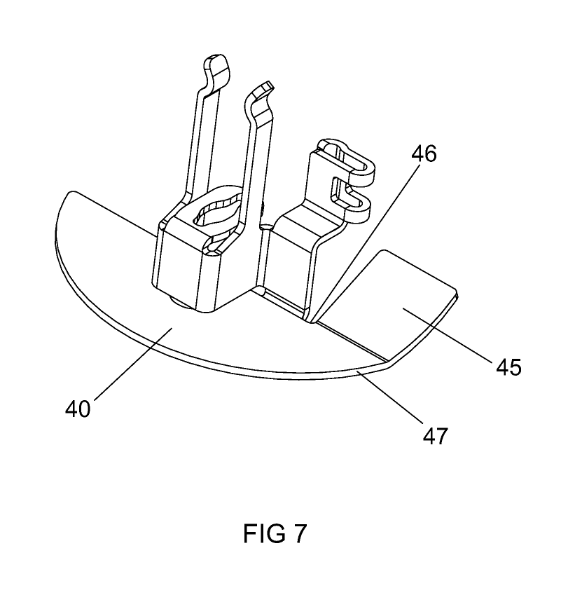

A second side wall 24 is arranged axially parallel beneath the second broad side. Otherwise, it has the same design as the first side wall 23. The two side walls are connected by a base wall 25, with bent transitions between these three plate elements being provided. In this case, the base wall is beneath the first narrow side of the pinch seal (see FIGS. 5 and 6 in this regard).

Two spring tongues 26 are arranged on the upper edge of the two side walls in such a way that they are opposite one another and, in the process, surround the two broad sides 8a and 8b of the pinch seal.

A centering run-in portion 28 extends in the form of a plate between the base of the two spring tongues 26 from the base wall 25, bent back towards said base wall through 90°. This is substantially a rectangular plate which has a substantially oval opening 29 in the center and which is intended for centering the free bent-back end of the outer power supply line 11 and making contact therewith (see primarily FIG. 6a in this regard).

Furthermore, an auxiliary plate 30 which is bent back at right angles and which branches off from the outer edge 31 of the side wall rests on a first side wall 23. An extension part 32 is bent back at the upper edge of this auxiliary plate, said extension part being oriented transversely to the longitudinal axis A, in a similar manner to the centering run-in portion 28. The docking station 33 for the feedline coming from the base 2 rests on the outer end of the extension part 32.

The docking station 33 is in the form of a clamping part with two side walls 34 and a bridge part 35 connecting said side walls with the result that the basic shape of the clamping part is similar to a U or C. For easier bending of the side walls 34, the clamping part 33 has a distinct central window 36 in the region of the bridge part. The feedline 13, which protrudes out of the plate-like stand 12 upwards in the direction of the built-in lamp 6, is clamped in between the two side walls 34 of the clamping part.

In this exemplary embodiment, the further design of the holding clip part 21 furthermore also comprises two pins 38, which protrude downwards from the side walls 23, 24 of the basic body, in the opposite direction to the spring tongues 26. Their length approximately corresponds to from three to six times the thickness of the sheet metal used for the holding clip.

These pins 38 serve the purpose of locking a reflector disk 40, which is in principle in the form of a half-plate and which is arranged substantially transversely to the longitudinal axis A (see FIGS. 6a and 6b in this regard). The half-plate is arranged at the level of the plate-like stand 12 in the region of a flattened end 41 of the plate-like stand. Correspondingly, it has a rectangular cutout 42 for matching to the flattened end. In the center of the cutout 42, a slot 43 is introduced transversely thereto, said slot serving to receive the bent section 44 of the outer power supply line 11 (see FIG. 6b).

An identical reflector disk 40 is also attached to the second clip element 21, which is fitted to the other end of the pinch seal, with the result that both half-plates together form a more or less complete reflective cover with respect to the base.

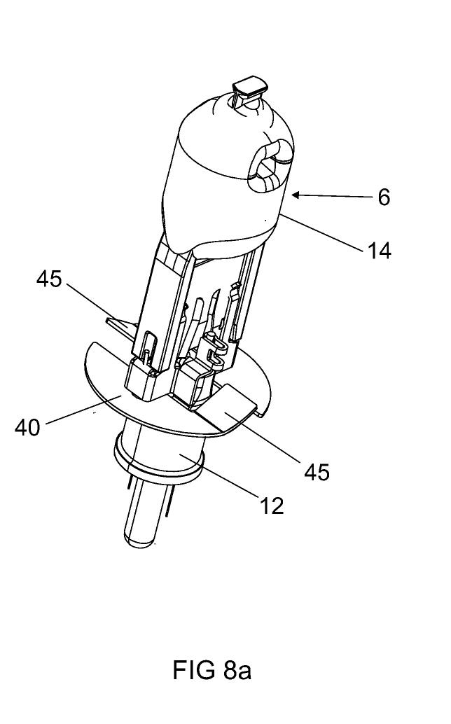

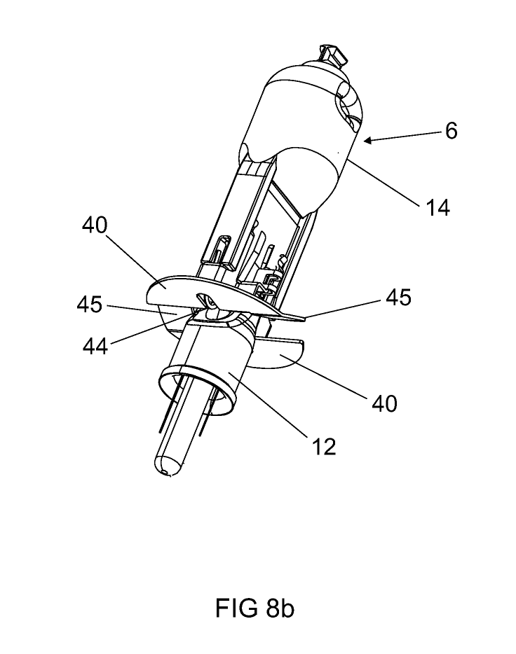

FIGS. 7 and 8 show a further exemplary embodiment of a reflector disk 40. Said reflector disk is in the form of a type of half-plate and does not have a rectangular cutout for matching to the flattened end of the plate-like stand. Instead, it has a fin 45 which is bent back slightly towards the plane of the half-plate and which on one side at one end of the half-plate, where the inner edge 46 of the half-plate and the externally peripheral arc piece 47 meet as rims. The length of the fin 45 is dimensioned such that it bridges the distance to the opposite half-plate almost completely or preferably even bridges this distance in overlapping fashion. Furthermore, the fin 45 is also preferably slightly inclined with respect to the plane of the half-plate 40. In the end result, there is therefore a large-area coverage of the base region, as a result of which the efficiency is markedly improved owing to the back-reflection on the two half-plates 40.

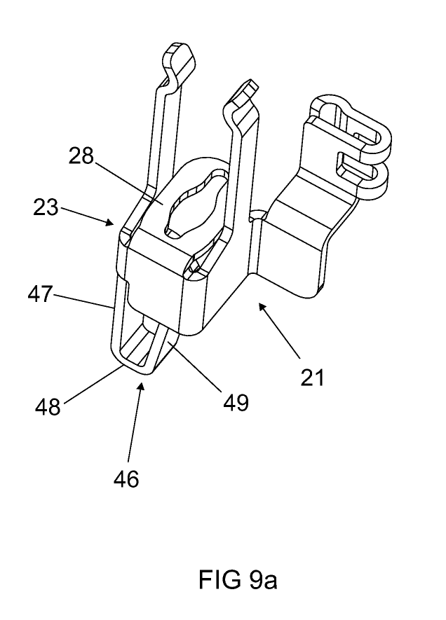

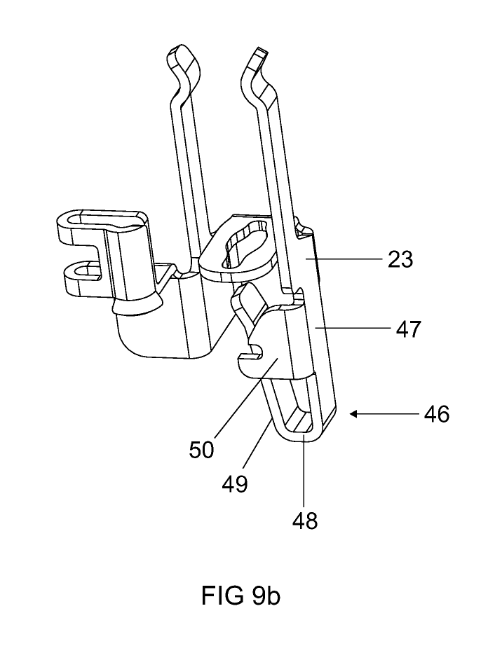

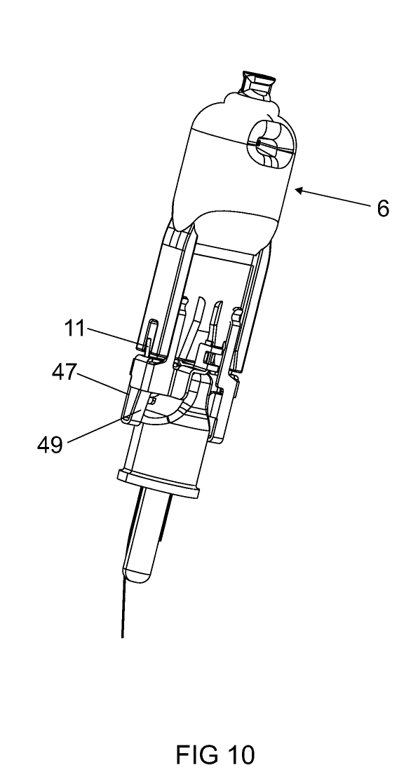

FIGS. 9 and 10 show a further exemplary embodiment of a clip part 21. This is in principle similar to the clip part 21 described in FIG. 7. However, it does not have any pins for attaching a reflector disk. Instead, the contact with the external power supply line 11 has another form.

For this purpose, a stirrup-shaped latch-in spring 46 rests on the basic body, in this case in the region of a first side wall 23 on the lower edge thereof. This latch-in spring has a rigid limb 47, which points downwards away from the edge of the side wall, a bridge part 48, which produces the bend, and a free, spring limb 49 which runs approximately parallel to the rigid limb and is bent back again and which ends beneath the centering run-in portion 28. In particular, as is shown, a stabilizing plate 50 can also be attached laterally, in particular bent back through 90°, on the rigid limb 47, said stabilizing plate extending in the direction of the plate-like stand 12 and maintaining a distance therefrom.

The latch-in spring 46 presses with its free limb 49 against the outer power supply line 11, as a result of which the mechanical contact with respect thereto is markedly improved. Laser welding for the connection is not absolutely necessary for this but is quite advantageous.

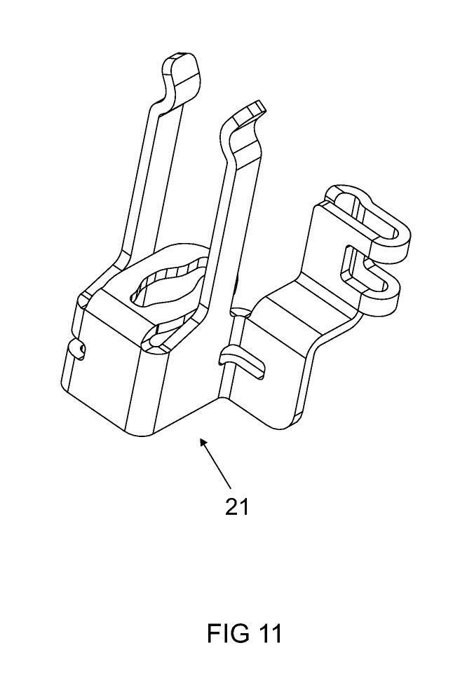

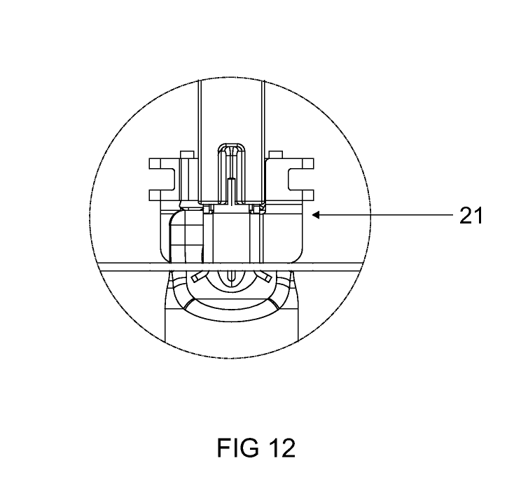

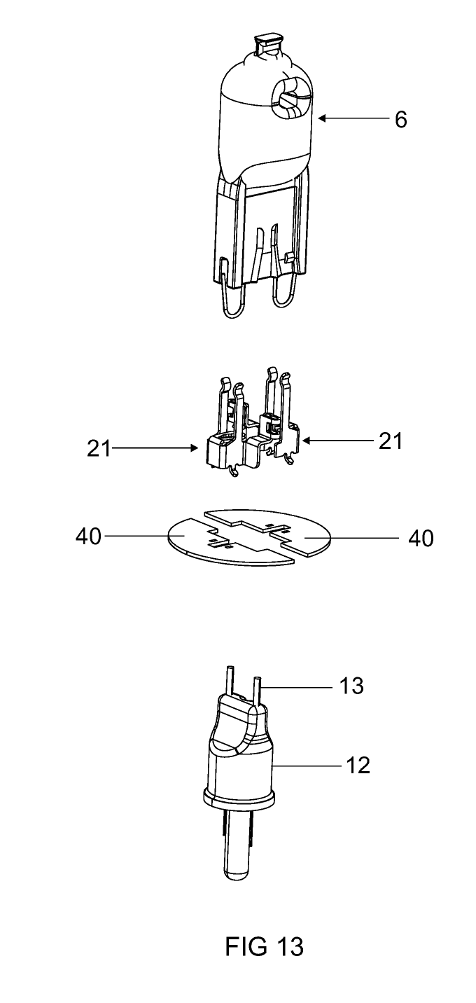

FIGS. 11 to 13 show an exemplary embodiment of a clip part 21 without pins, which otherwise corresponds to the exemplary embodiment shown in FIGS. 5 and 6.

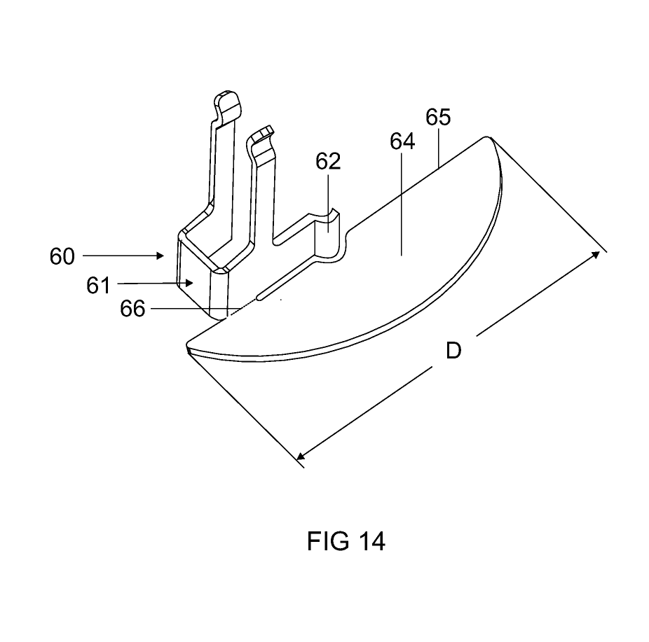

FIG. 14 shows a further exemplary embodiment of a clip part 60 with an integrated reflector disk. In this case, the basic body 61 is bent in the form of a U and the docking station 62 is attached directly to the outer edge of the first side wall 63. A reflector disk 64 is attached as a half-plate from the lower edge of a side wall, preferably the first side wall 63. Said reflector disk extends with its inner edge 65 along the side wall 63, wherein this half-plate 64 has a longitudinal dimension D, in the sense of a diameter which corresponds at least to the width B of the broad side of the pinch seal; better still it is 1.1 to 1.3 times B, i.e. 1.1 B≦D≦1.3 B. In this exemplary embodiment, therefore, the longitudinal dimension of the half-plate extends in one direction, which is transverse to the direction of the previous embodiments of the half-plate. This half-plate is integrally attached to the first side wall 63 via a bridge 66 and then the bridge 66 is bent back.

A fitting method with the aid of the holding clip involves the following sequential steps: first, the first and second clip parts and the built-in lamp with bent-back outer power supply lines are provided.

Then, the built-in lamp is inserted into the holding clip by the pinch seal being introduced into the two spring tongues, as a result of which said built-in lamp is fixed, wherein the built-in lamp is pushed between the spring tongues until its base part of the pinch seal rests on the basic body or the centering run-in portion. In this case, at the same time, the feedlines are clamped into the docking stations provided for this purpose.

Then, the first outer power supply line of the built-in lamp is connected to the bottom plate by laser welding. The contact is alternatively provided purely mechanically or by means of resistance welding. At the same time or in quick succession to this, the docking station is also welded to the feedline, when the purely mechanical contact is considered to be insufficient.

A reflector disk is possibly now attached to each clip part if this is desired and if this has not automatically been provided already as an integral part on the clip part.

Then, cement is introduced into the base sleeve 4 and the structural unit comprising the built-in lamp and the holding clip is inserted into the base sleeve, the electrical contact to the base sleeve being ensured by the two feedlines.

Then, the outer bulb 13 is fitted into the base sleeve and the cement is baked. The escaping gases are sucked away in the process by subatmospheric pressure via the contact plate, which is still open in the form of an eyelet. Then, an extension wire of a feedline or a feedline itself is cut to length at the level of the contact plate and soldered to the contact plate.

Since the basic body is electrically connected to the base sleeve via a first feedline, the side contact is thus realized. Central contact is realized by virtue of the extension wire being soldered in the contact plate of the base, namely the eyelet.

Another type of base, such as a bayonet base, for example, is of course also suitable for the lamp.

The reflector part 40 itself consists of spring steel or a spring plate, for example, as is the case for the holding clip 21, wherein the reflector part in addition can also have a reflecting coating on its upper side. Preferably, the reflector part is manufactured from aluminum, which is high-gloss-coated or plated.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims 2011P067 and all changes which come within the meaning and range of equivalency of the claims are therefore intended to be embraced.

1. An electric lamp with an outer bulb and with a base fastened thereto by means of a plate-like stand and also with a built-in lamp with a longitudinal axis, the outer bulb surrounding the built-in lamp, which is equipped with a pinch seal with two narrow sides and two broad sides, two outer power supply lines protruding out of the pinch seal and being electrically conductively connected for their part to feedlines leading to the base, the built-in lamp being held without the use of cement by a holding clip, wherein the holding clip has at least one clip part, which has a basic body which is bent in the form of a U, two spring tongues being arranged on the basic body in such a way that they embrace the broad sides of the pinch seal, a docking station for a feedline also being attached to the basic body, and contact being made between the basic body and an outer power supply line.

2. The lamp as claimed in claim 1, wherein the basic body and the docking station are positioned at different heights with respect to the longitudinal axis.

3. The lamp as claimed in claim 1, wherein the basic body has a base wall, a centering run-in portion being bent back from the basic body.

4. The lamp as claimed in claim 1, wherein the basic body and the docking station are connected via an auxiliary plate, which is bent back towards the basic body.

5. The lamp as claimed in claim 1, wherein a reflecting disk segment, which extends transversely to the longitudinal axis, is associated with the clip part.

6. The lamp as claimed in claim 5, wherein the basic body has pin-like protuberances, the disk segment having corresponding cutouts for locking the disk segment.

7. The lamp as claimed in claim 5, wherein the disk segment is attached integrally to the basic body, in particular to a side wall of the basic body.

8. The lamp as claimed in claim 1, wherein the outer power supply line is bent back laterally towards the narrow side of the pinch seal.

9. The lamp as claimed in claim 5, wherein the disk segment additionally has a fin, which enlarges the area for the reflection.

10. The lamp as claimed in claim 1, wherein a stirrup-shaped latch-in spring for making contact with the bent-back outer power supply line is attached to the basic body, in particular with a rigid limb which is fastened on the basic body, a bridge part and a free limb, which presses laterally against the outer power supply line.

11. A method for producing an electric lamp as claimed in claim 1, wherein, in a first step, an extension wire is connected to a second outer power supply line of the built-in lamp, then the built-in lamp is mechanically connected to the holding clip, the skirt is placed in particular between at least two spring tongues, then the first outer power supply line is connected directly to the skirt, in particular by means of a bead formed on the skirt, then cement is introduced into the base sleeve, then the structural unit comprising the built-in lamp and the holding clip is placed into the base sleeve whilst making contact between the spring feet and the base sleeve, then the outer bulb is placed onto the base sleeve, then the cement is baked, and finally the contact plate is connected to the extension wire.

12. A method for producing an electric lamp as claimed in claim 9, wherein, in a first step, an extension wire is connected to a second outer power supply line of the built-in lamp, then the built-in lamp is threaded through the reflector part and is mechanically connected to the holding clip, the skirt is placed in particular between at least two spring tongues, then the first outer power supply line is connected directly to the skirt, in particular by means of a bead formed on the skirt, then cement is introduced into the base sleeve, then the structural unit comprising the built-in lamp and the holding clip is placed into the base sleeve so as to make contact between the spring feet and the base sleeve, then the outer bulb is placed onto the base sleeve, then the cement is baked, and finally the contact plate is connected to the extension wire.
